(19) United States
(12) Patent Application Publication
(10) Pub. No.: US 2014/0149963 A1
(43) Pub. Date: May 29, 2014

(54) METHOD AND APPARATUS FOR COMBINING ROBOT SOFTWARE COMPONENTS

(71) Applicant: Electronics and Telecommunications Research Institute, Daejeon (KR)

(72) Inventors: Choulsoo JANG, Daejeon (KR); Byoung Youl SONG, Daejeon (KR); Seung-Woog JUNG, Daejeon (KR); Sung Hoon KIM, Daejeon (KR)

(21) Appl. No.: 13/945,398

(22) Filed: Jul. 18, 2013

(30) Foreign Application Priority Data
Nov. 26, 2012 (KR) 10-2012-0134320

(51) Int. Cl. G06F 9/44

(52) U.S. Cl. CPC G06F 8/34
USPC 717/107

(57) ABSTRACT

In accordance with an embodiment, when robot service developers develop the component-based robot software, they are able to select a tight coupling or a loose coupling to develop the component-based robot software and connect the components in compliance with the coupling types that are supported by the components in the component combination tool for combining the components. Therefore, it is possible to make a robot application system in which the components having different coupling types are used all together.

### RELATED APPLICATIONS

This application claims the benefit of Korean Patent Application No. 10-2012-0134320, filed on Nov. 26, 2012, which is hereby incorporated by reference as if fully set forth herein.

### FIELD OF THE INVENTION

The present invention relates to a combination of software components for robots, and more particularly, to an apparatus and method for combining robot software components capable of connecting the robot software components in compliance with a coupling type supported by the components when developing a component-based robot software.

### BACKGROUND OF THE INVENTION

Robot software components are software modules that can be re-used and replaced. From a standpoint of a user, the user uses only interfaces furnished by the robot software components without the necessity to know implementation details of the interfaces and constitutes a robot application with only the combination of the robot software components.

The individual components, which are made under a component-based development methodology, perform the role of an agent of the devices in the real world and various algorithms. Robot developers are able to combine the components that have made already and tested separately to complete a robot service.

The respective robot components employed in a robot software architecture have different internal states, operate in an active way and perform data exchange and method calls between the components through their component interfaces, thereby controlling the robot. Recently, in order to support these features of the robot, software platforms such as OPRoS (Open Platform for Robotic Services), RTC (Robot Technology Component), Orocos (Open RObot Control Software) and ROS (Robot Operating System) have suggested the programming method of the robot using the components.

Among of them, the software platforms of the OPRoS, RTC and Orocos use a tight coupling to connect directly between the interfaces provided by the individual components by using methods such as TCP/IP. The software platform of the ROS uses a loose coupling so that the components can be connected through a medium of a topic that supports subscribing/publishing method between the components.

As such, in a component-based robot software development method, there coexists the tight coupling in which the components are directly connected with each other and the loose coupling in which the components are connected via an intermediate medium. Owing to that, the components having different connection types suffer from a difficult that they cannot communicate with each other.

A component combination device utilized in a component-based software platform provides a GUI (Graphic User Interface)-based modeling tool for the combination of the components which allow a robot service developer to connect the individual components on a package diagram to complete a robot application package. When the GUI-based tool for the component combination is used to combine the components, the developer is able to combine the components while confirming visually how interface ports of the components are connected to other components; therefore, it is possible to complete the application package by combining the components easily.

However, the components that support the tightly coupled connection need be directly connected between them, while the components that support the loosely coupled connection need be connected through an intermediate medium instead of directly connecting between them. Accordingly, there occurs a problem that they cannot be accommodated all together within the component combination device and its component combination tool.

### SUMMARY OF THE INVENTION

In view of the above, the present invention provides an apparatus and method for combining robot software components, which is capable of selecting a tight coupling and a loose coupling to develop a component-based robot software when developing the component-based robot software and connecting the components in compliance with the coupling types that are supported by the components in a component combination tool for combining the components.

In accordance with a first aspect of the exemplary embodiment of the present invention, there is provided an apparatus for combining robot software components, the apparatus includes: a code generator configured to interpret a component standard that is input to generate a component source code made with a tight coupling or a loose coupling; a component storage unit that stores the generated component source code; a GUI (Graphic User Interface) processor configured to provide a component combination tool including a component list display window, a topic list display window and an application diagram display window through a GUI environment; a component list generator configured to interpret the component standard of the stored component source code to acid components to a component list in the component list display window or add topics to a topic list in the topic list display window; a pointing input unit configured to allow drawing an individual component displayed on the component list display window or an individual topic displayed on the topic list display window and putting it on the application diagram display window; and an application package creator configured to make connection information into an application package, wherein the connection information includes information in which a port having the loose coupling in the component is connected to a topic or a port having the tight coupling in the component is directly connected to a port in other components in the application diagram display window.

Further, the method may the code generator is configured to, when the component standard is made with the tight coupling, generate the component source code to include a client code as for an output type port.

Further, the code generator is configured to, when the component standard is made with the tight coupling, generate the component source code to include a server code as for an input type port.

Further, the code generator is configured to, when the component standard is made with the loose coupling, generate the component source code to publish on a corresponding topic as for an output type port.

Further, the code generator is configured to, when the component standard is made with the loose coupling, generate the component source code to subscribe to a corresponding topic in a case of an input type port.

Further, the component list generator is configured to, when the component has an expansion tag of a type, determine that the component is made with the loose coupling and register the topic in the topic list in the topic list display window.

Further, comprise a component connector configured to: when the individual component displayed on the component list display window are drawn and put on the application diagram display window, interpret the component standard; and when an interface port in the component is made with the loose coupling, mark near the port a note that the port is connected to the topic.

Further, the application package configuration standard creator is configured to, when the port is made with the tight coupling, create the connection information which specifies the component in a source and a target of the application package so that a direct connection is made between the components.

Further, the application package configuration standard creator is configured to, when the port is made with the loose coupling, create the connection information included in the application package which specifies a source as the component and a target as a topic as for a publication and vice versa as for a subscription so that the component and the topic are connected.

In accordance with a second aspect of the exemplary embodiment of the present invention, there is provided a method for combining robot software components, the method includes: interpreting a component standard that is input to generate a component source code made with the tight coupling or the loose coupling; providing a component combination tool including a component list display window, a topic list display window and an application diagram display window through a GUI environment; interpreting the component standard of the generated component source code to add components to a component list in the component list display window or add topics to a topic list in the topic list display window; allowing drawing an individual component displayed on the component list display window or an individual topic displayed on the topic list display window and putting it on the application diagram display window; and making connection information in which a port having the loose coupling in a component is connected or a port having the tight coupling is directly connected to a port in other components on the application diagram display window into an application package.

Further, the method may interpreting a component standard comprises: when the component standard is made with the tight coupling, generating the component source code to include a client code as for an output type port.

Further, interpreting a component standard comprises: when the component standard is made with the tight coupling, generating the component source code to include a server code as for an input type port.

Further, interpreting a component standard comprises: when the component standard is made with the loose coupling, generating the component source code to publish on a corresponding topic as for an output type port.

Further, interpreting a component standard comprises: when the component standard is made with the loose coupling, generating the component source code to subscribe to a corresponding topic as for an input type port.

Further, interpreting the component standard of the generated component source code comprises: when the component has an expansion tag of type, determining that the component is made with the loose coupling to register a topic in the topic list in the topic list display window.

Further, comprise when the individual component displayed on the component list display window is drawn and put it on the application diagram display window, interpreting the component standard; and when an interface port in the component is made with the loose coupling, marking near the port a note indicating that the port is connected to the topic.

Further, creating an application package comprises: when the port is made with the tight coupling, creating the connection information which specifies the component in a source and a target of the application package so that a direct connection is made between the components.

Further, creating an application package comprises: when the port is made with the loose coupling, creating the connection information included in the application package which specifies a source as the component and a target as a topic as for a publication and vice versa as for a subscription so that the component and the topic are connected.

In accordance with an embodiment of the present invention, when robot service developers develop the component-based robot software, they are able to select a tight coupling or a loose coupling to develop the component-based robot software and connect the components in compliance with the coupling types that are supported by the components in the component combination tool for combining the components. Therefore, it is possible to make a robot application system in which the components having different coupling types are used all together.

### BRIEF DESCRIPTION OF THE DRAWINGS

The above and other objects and features of the present invention will become apparent from the following description of the embodiments given in conjunction with the accompanying drawings, in which:

FIG. 1 is an exemplary diagram of a robot software component used in an embodiment of the present invention;

FIG. 2 is a block diagram of an apparatus for combining robot software components in accordance with an embodiment of the present invention; and

FIG. 3 is an output example of a component standard of a tight coupling;

FIG. 4 is an output example of a component standard of a loose coupling;

FIG. 5 is a flowchart illustrating a process for generating source codes performed by an apparatus for combining robot software components in accordance with an embodiment of the present invention;

FIG. 6 is a flowchart illustrating a process for generating component and topic repositories performed by an apparatus for combining robot software components in accordance with an embodiment of the present invention;

FIG. 7 is an exemplary diagram illustrating a view of a component representation on a component combination tool provided from an apparatus for combining robot software components in accordance with an embodiment of the present invention;

FIG. 8 is an exemplary diagram illustrating a view of the component and topic representations on a component combination tool provided from an apparatus for combining robot software components in accordance with an embodiment of the present invention;

FIG. 9 is an exemplary diagram illustrating a view of the connection between a component and a topic on a component combination tool provided from an apparatus for combining robot software components in accordance with an embodiment of the present invention; and

FIG. 10 is an exemplary diagram of an application package created by an apparatus for combining robot software components in accordance with an embodiment of the present invention.

### DETAILED DESCRIPTION OF THE EMBODIMENTS

Advantages and features of the invention and methods of accomplishing the same may be understood more readily by reference to the following detailed description of embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims. Like reference numerals refer to like elements throughout the specification.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Hereinafter, embodiments of the present invention will be described in detail with reference to the accompanying drawings.

A robot service is composed of the connection of robot software components, and a component connection method via ports is used to lower the degree of coupling between the components. A term of “port” used herein refers to a point at which the components interact with an external environment. The components connect with other components through the port and perform a mutual communication. By achieving the connection between the components via the port, a user uses only the interface furnished by the components and needs not to know implementation details of the interface. To put it another way, the component becomes a black box that cannot know other than the interface that is revealed explicitly. Thus, as long as an external interface does not change, the inner implementation of the component becomes possible to freely change.

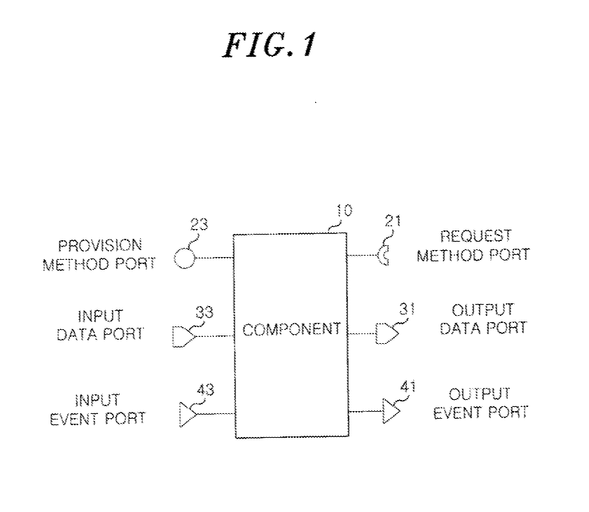

In the component-based robot software, the components make a mutual connection with each other to communicate between them. The connection between the components is carried out through the connection between ports of receiving components and ports of transmitting components. A variety of communication methods can be used depending on the kinds of information between the robot software components, for example, a communication method such as an RPC (Remote Procedure Call) which is used mainly for a remote method call between the components, a method to periodically transfer data between the components or a method to intermittently forward an event that is occurring. The components can arbitrarily select to use a necessary method of these methods. By way of example, for an OPRoS (Open Platform for Robotic Services), as shown in FIG. 1, a component 10 furnishes a method port for the RPC. When it is necessary to call an external method, the component furnishes a request method port 21, and when it is necessary to provide services to the outside, the component furnishes a provision method port. Further, the component 10 furnishes an output data port 31 when it desires to send data periodically to the outside, the component furnishes an input data port 33 when it desires to input data periodically from the outside, and similarly, the component 10 furnishes an input event port 41 and an output event port 43 for the events.

In order to support such different interfaces when developing the software components, when the component developer is allowed to declare only a specification of the component interface (i.e., profile) from the component developer, a code generator automatically generates the source code to suit each interface. That is, in a case where the components are connected by a method such as TCP/IP, when the component developer specifies to use the method port, the code generator generates a component source code so that a client code and server code for the remote method call are automatically included; when a data port is declared, the code generator automatically generates a component source code which contains data marshalling/unmarshalling codes and buffering functionality; and when the event port is declared, the code generator automatically generates a component source code that contains a source code which can process an event data.

The component modeling tool for the combination of the components arranged by the apparatus for combining robot software components in accordance with an embodiment of the present invention is used to create the robot application by combining the components. The component combination tool has a component repository that can store the components that were created separately. The components stored in the repository appear in the form of a list as icons on a screen of a component list display window so that they can be used in the development of the robot application. A robot application developer just drags the individual component that is displayed in the list using a pointing device such as a mouse device and puts it on an application diagram display window. Then, interface ports included in the components are displayed, the robot application developer connects the ports between the components to create the robot application package.

As such, the component-based software platform makes the components, which exchange data with each other, to be tightly coupled between them and makes a connection between the components using an exclusive tool of the platform to configure the application package for a robotic service.

However, for ROS (Robot Operating System), it performs a communication between components via a medium of a topic that supports subscription/publication method, instead of directly connecting the components with each other. In other words, the ROS uses the loose coupling in which the components are connected indirectly through a topic instead of directly connecting the components which exchange data with each other in such a manner that a component that wants to receive data from other component is allowed to be registered in an interest topic, which plays the role of the communication channel, and a component that seeks transfer data is allowed to publish data in a desired topic, so that the data is transmitted to the component that is subscribed in the topic to process the data. The loose coupling is slow in terms of data transfer rate compared to the tight coupling in which the components are connected directly, but it has a flexible combination capability against to the tight coupling because it is not necessary to know that the data is going to which component, or came from which component.

That is, in terms of data rate, the tight coupling is advantageous, and in terms of a flexible combination, the loose coupling is advantageous. Accordingly, it is preferable to properly utilize two types.

However, because the software platform that supports the tight coupling and the software platform that supports the loose coupling backs up only the type of themselves, components generated by their types cannot be used all together simultaneously.

Accordingly, the exemplary embodiments of the present invention allow selecting a connection type of the tight coupling and the loose coupling to develop the software components when developing the software components, and allows the component combination tool to connect the components for the combination of the components in compliance with the coupling type supported by the components.

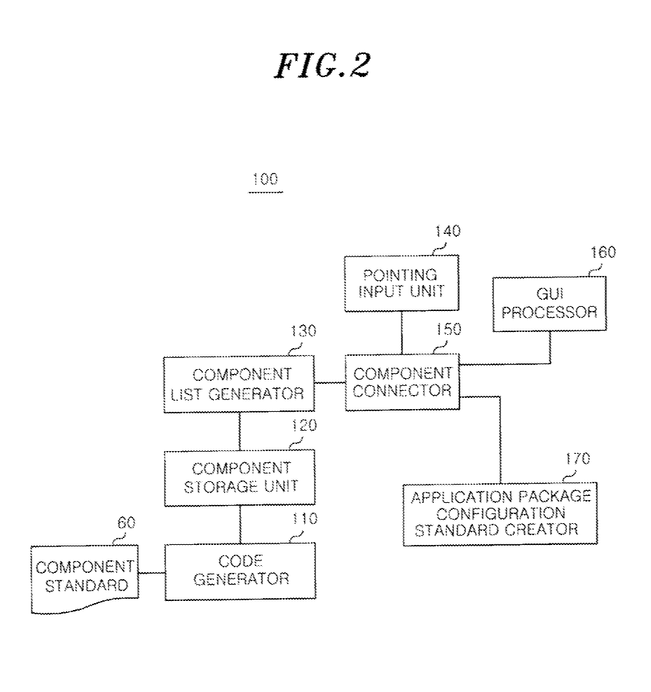

FIG. 2 is a block diagram of an apparatus for combining robot software components in accordance with an embodiment of the present invention.

As illustrated in FIG. 2, a robot software component combining apparatus 100 includes a code generator 110, a component storage unit 120, a component list generator 130, a pointing input unit 140, a component connector 150, a GUI (Graphic User Interface) processor 160 and an application package creator 170.

The code generator 110 interprets a component standard 60 that is input to generate a component source code in a tight coupling or a loose coupling.

When the component standard 60 is made with the tight coupling, the a code generator 110 generates a component source code to include a client code as for an output type port and generates a component source code to include a server code as for an input type port.

In addition, when the component standard 60 is made with the loose coupling, the code generator 110 generates a component source code to publish on a corresponding topic as for an output type port and generates a component source code to subscribe to a corresponding topic as for an input type port.

The component storage unit 120 stores the component source codes generated by the code generator 110.

The GUI processor 160 provides a component combination tool including a component list display window and a topic list display window through GUI environment.

The component list generator 130 interprets the component source code stored in the component storage unit 120 and adds the component to the component list in the component list display window or adds the topic to the topic list in the topic list display window.

The pointing input unit 140 supports a function to draw an individual component displayed on the component list display window or an individual topic displayed on the topic list display window to put it on an application diagram display window.

When the individual component displayed on the component list display window is drawn by the pointing input unit 140 and put on the application diagram display window, the component connector 150 interprets the component standard and marks a note near an interface port that the port is connected to the topic in a case where the port is made with the loose coupling.

When there is information on that a port of the loose coupling in a component is connected to a topic or a port of the tight coupling is directly connected to a port of other components on the application diagram display window, the application package creator 170 makes the connected information into an application package configuration standard.

When a port is made with the tight coupling, the application package creator 170 creates connection information which specifies the components in the source and target of the application package so that the components are directly connected with each other. In addition, when a port is made with the loose coupling, the application package creator 170 creates the connection information included in the application package which specifies the source as the component and the target as a topic as for a publication and vice versa as for a subscription, so that the component and the topic are connected with each other.

Hereinafter, a description will be made on a method for combining robot software components performed by an apparatus for combining robot software components in accordance with an embodiment of the present invention with reference to FIGS. 2 to 10.

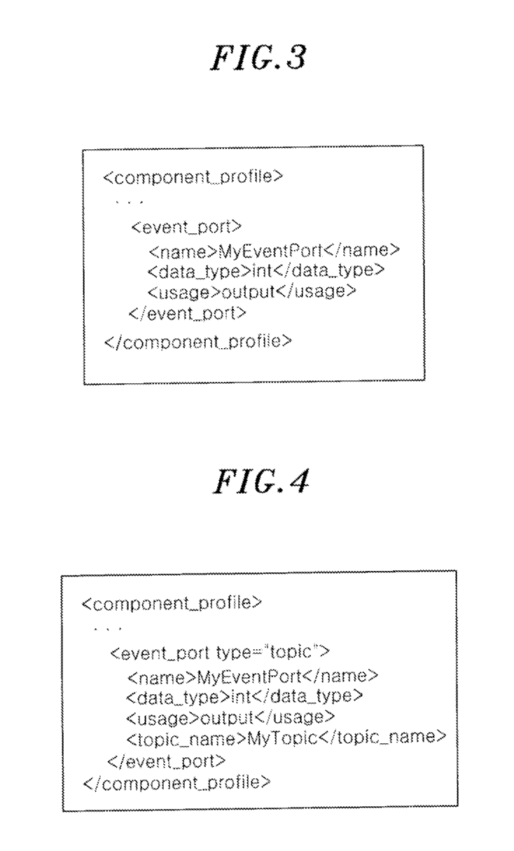

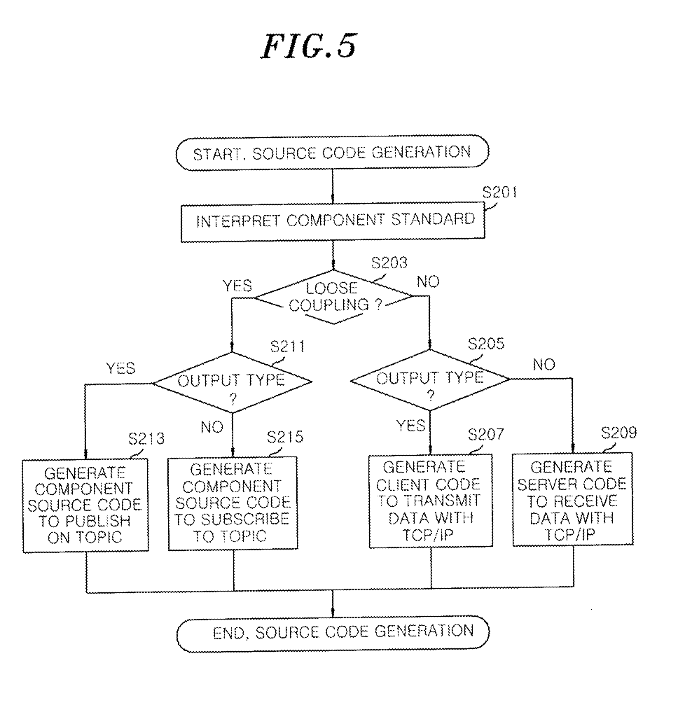

When the software component is developed, in order to select one of the tight coupling or the loose coupling for the development of the software component, the embodiment allows selecting whether an event port will be made with the tight coupling using an expansion tag such as a type in an event port declaration standard or the loose coupling using a topic. Further, when the event port is made with the loose coupling using the topic, the name of the topic to be connected in the component may be received additionally, and when the name of the topic name is specified in a procedure of combining the components, the name of the topic may be omitted. FIG. 3 illustrates an output example of a component standard of a loose coupling, and FIG. 4 illustrates an output example of a component standard of a loose coupling.

As illustrated in FIG. 5, when the component standard 60 is input, the code generator 110 interprets the component standard, in operation S201, and determines whether the component standard is made with the tight coupling or the loose coupling, in operation 3203.

When it is determined that the component standard is made with the tight coupling, as for an output type port in operation S205, the code generator 110 generates a component source code to include a client code, so that the components can be connected with each other using a method such as TCP/IP or the like, in operation S207, and as for an input type port in operation S205, the code generator 110 generates a component source code to include a server code, in operation S209.

On the other hand, when it is determined that the component standard is made with the loose coupling, as for an output type port in operation S211, the code generator 110 generates a component source code to publish in a corresponding topic, in operation S213, and as for an input type port in operation S211, the code generator 110 generates a component source code to subscribe in a corresponding topic, in operation S215.

The component source codes generated thereby is stored in the component storage unit the component storage unit 120, and the components can be connected using the component combination tool provided from the GUI processor 160. In this case, whether each component is made with the tight coupling or the loose coupling can be known from the reading of the component standard accompanying the component.

The components made with the tight coupling will have the addresses of the client to transmit data and the server to receive data to communicate mutually when they are connected in the component combination tool.

Meanwhile, when the name of the topic is given, the components made with the loose coupling subscribe or publish the corresponding topic; and when the name of the topic is not given, the components made with the loose coupling subscribes get the name of the topic during the procedure of combining the components to subscribe to or publish on the corresponding topic.

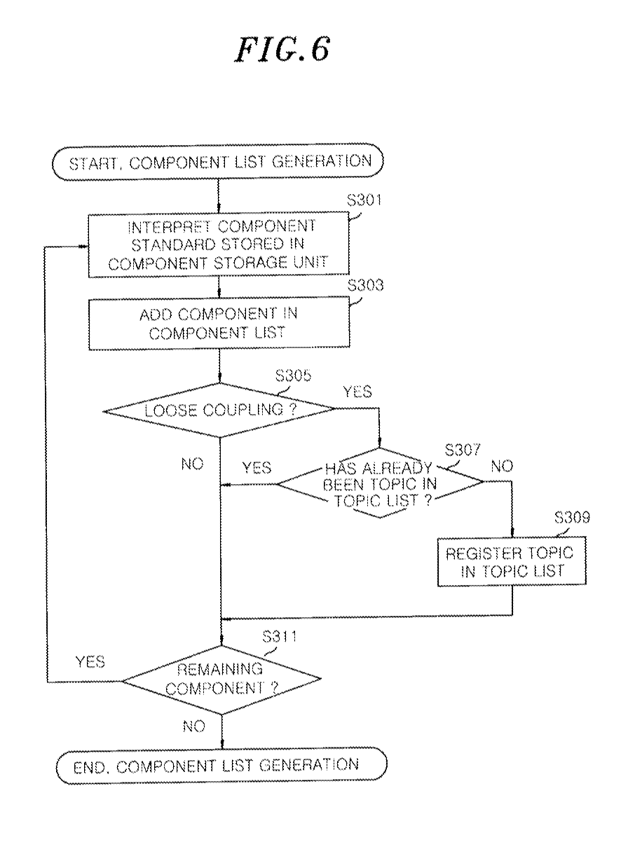

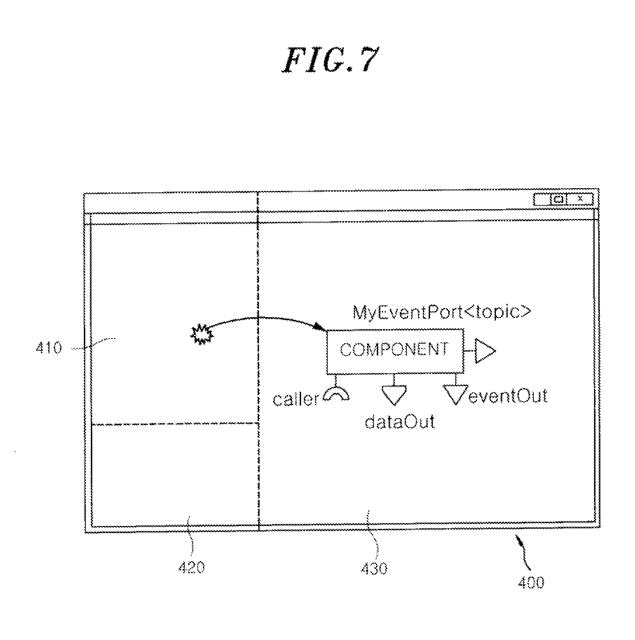

To do it, as illustrated in FIG. 6, the component list generator 130 interprets the component standard, in operation S301, to add the component in the component list in the component combination tool, in operation S303. The component list generator 130 determines that the component is made with the loose coupling when the component has an expansion tag of type, in operation S305, and registers the topic in the topic list in the component combination tool, in operation S309. In this case, if the topic having the same name has been already registered in the topic list when registering the topic in the topic list, the registration will not be additionally made since the topic which has already registered can be available, in operation S307. Meanwhile, the method repeats from the operation S301 as long as the other components remain, in operation S311.

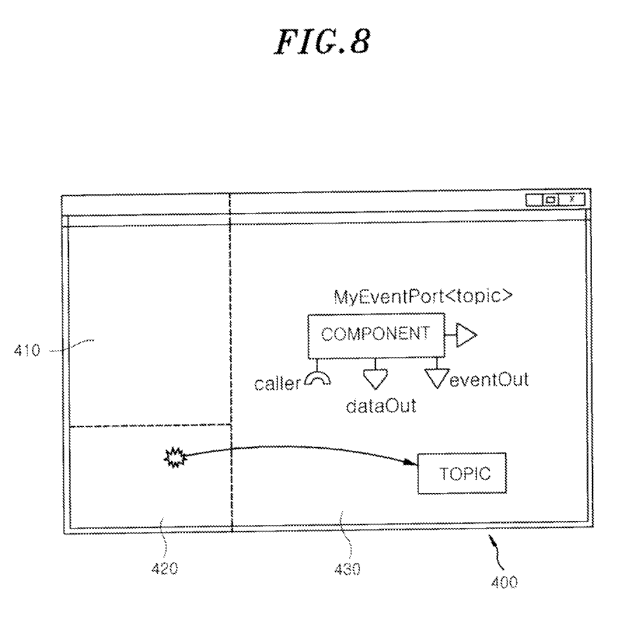

The GUI processor 160, as illustrated in FIG. 7, provides the component combination tool 400 through the GUI. The component combination tool 400 includes a component list display window 410, a topic list display window 420 and an application diagram display window 430.

As illustrated in FIG. 7, a robot application developer may draw an individual component displayed on the component list display window 430 using the pointing input unit 140 such as a mouse device and the like and puts it on the application diagram display window 430. If so, the component connector 150 interprets the component standard to determine whether the component is made with the tight coupling or the loose coupling. Subsequently, when it is determined that an interface port of the component is made with the loose coupling, the component connector 150 marks near the port a note (e.g., MyEventPort<<topic>>) indicating that the port is connected to a topic.

The port having the note indicative of the connection to a topic cannot be directly connected ports in the other components, but can be connected to the topic having only the same data type, (data_type). In order to select the topic to which the component made with the loose coupling is connected, the robot application developer may draw the individual topic displayed on the topic list display window 420 using the pointing input unit 140 and puts it on the application diagram display window 430. If so, the topic is displayed on the application diagram display window 430 by the GUI processor 160.

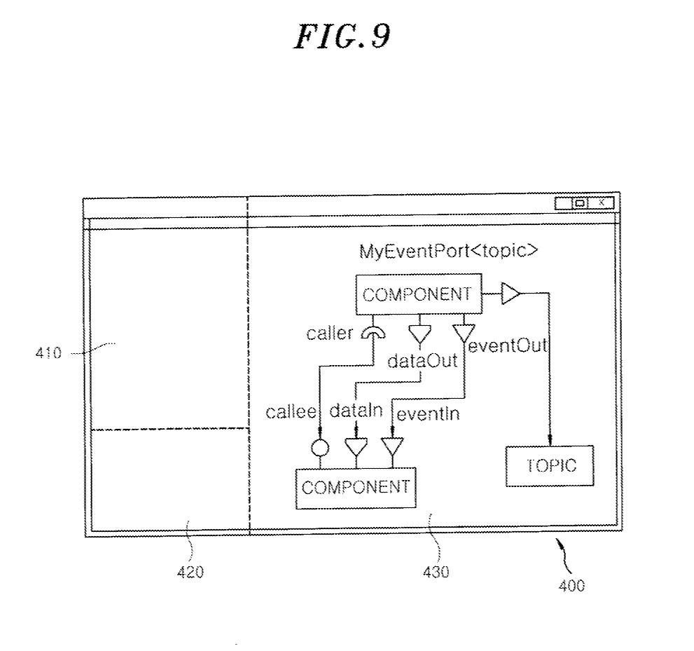

After the topic has been put on the application diagram display window 430, as illustrated in FIG. 9, the port made with the loose coupling is connected to the topic. When the components support both the tight coupling and the loose coupling, the port having the loose coupling is connected to the topic and the port having the tight coupling is directly connected to a port in other components.

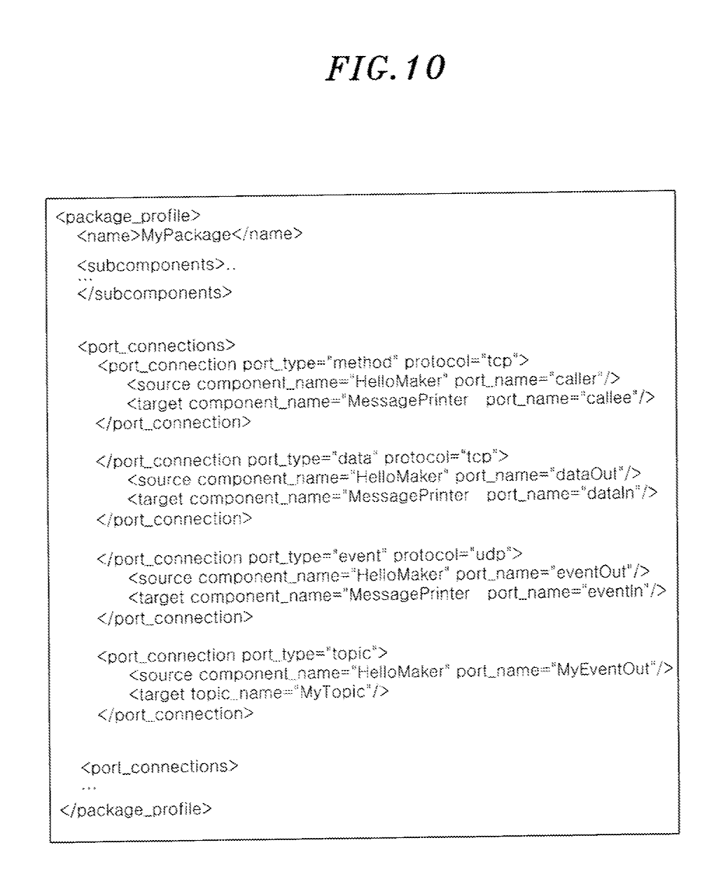

Information on the connection like this is made in the application package by the application package creator 170. When the port is made with the tight coupling, the application package creator 170 creates the connection information in the application package which specifies the components in source and target in order to make a direct connection between the components. Meanwhile, when the port is made with the loose coupling, the application package creator 170 creates the connection information included in the application package which specifies the source as the component and the target as a topic as for the publication and vice versa as for the subscription in order to make a connection of the component and the topic. FIG. 10 exemplarily illustrates an application package including the topic.

While the description of the present invention has been made to the exemplary embodiments, various changes and modifications may be made without departing from the scope of the invention. Therefore, the scope of the present invention should be defined by the appended claims rather than by the foregoing embodiments.

What is claimed is:

1. An apparatus for combining robot software components, the apparatus comprising:
a code generator configured to interpret a component standard that is input to generate a component source code made with a tight coupling or a loose coupling;
a component storage unit that stores the generated component source code;
a GUI (Graphic User Interface) processor configured to provide a component combination tool including a component list display window, a topic list display window and an application diagram display window through a GUI environment;
a component list generator configured to interpret the component standard of the stored component source code to add components to a component list in the component list display window or add topics to a topic list in the topic list display window;
a pointing input unit configured to allow drawing an individual component displayed on the component list display window or an individual topic displayed on the topic list display window and putting it on the application diagram display window; and
an application package creator configured to make connection information into an application package, wherein the connection information includes information in which a port having the loose coupling in the component is connected to a topic or a port having the tight coupling in the component is directly connected to a port in other components in the application diagram display window.

2. The apparatus of claim 1, wherein the code generator is configured to, when the component standard is made with the tight coupling, generate the component source code to include a client code as for an output type port.

3. The apparatus of claim 1, wherein the code generator is configured to, when the component standard is made with the tight coupling, generate the component source code to include a server code as for an input type port.

4. The apparatus of claim 1, wherein the code generator is configured to, when the component standard is made with the loose coupling, generate the component source code to publish on a corresponding topic as for an output type port.

5. The apparatus of claim 1, wherein the code generator is configured to, when the component standard is made with the loose coupling, generate the component source code to subscribe to a corresponding topic in a case of an input type port.

6. The apparatus of claim 1, wherein the component list generator is configured to, when the component has an expansion tag of a type, determine that the component is made with the loose coupling and register the topic in the topic list in the topic list display window.

7. The apparatus of claim 1, further comprising:
a component connector configured to:
when the individual component displayed on the component list display window are drawn and put on the application diagram display window, interpret the component standard; and
when an interface port in the component is made with the loose coupling, mark near the port a note that the port is connected to the topic.

8. The apparatus of claim 1, wherein the application package configuration standard creator is configured to, when the port is made with the tight coupling, create the connection information which specifies the component in a source and a target of the application package so that a direct connection is made between the components.

9. The apparatus of claim 1, wherein the application package configuration standard creator is configured to, when the port is made with the loose coupling, create the connection information included in the application package which specifies a source as the component and a target as a topic as for a publication and vice versa as for a subscription so that the component and the topic are connected.

10. A method for combining robot software components, the method comprising:
interpreting a component standard that is input to generate a component source code made with the tight coupling or the loose coupling;
providing a component combination tool including a component list display window, a topic list display window and an application diagram display window through a GUI environment;
interpreting the component standard of the generated component source code to add components to a component list in the component list display window or add topics to a topic list in the topic list display window;
allowing drawing an individual component displayed on the component list display window or an individual topic displayed on the topic list display window and putting it on the application diagram display window; and
making connection information in which a port having the loose coupling in a component is connected or a port having the tight coupling is directly connected to a port in other components on the application diagram display window into an application package.

11. The method of claim 10, wherein said interpreting a component standard comprises:
when the component standard is made with the tight coupling, generating the component source code to include a client code as for an output type port.

12. The method of claim 10, wherein said interpreting a component standard comprises:
when the component standard is made with the tight coupling, generating the component source code to include a server code as for an input type port.

13. The method of claim 10, wherein said interpreting a component standard comprises:
when the component standard is made with the loose coupling, generating the component source code to publish on a corresponding topic as for an output type port.

14. The method of claim 10, wherein said interpreting a component standard comprises:
when the component standard is made with the loose coupling, generating the component source code to subscribe to a corresponding topic as for an input type port.

15. The method of claim 10, wherein said interpreting the component standard of the generated component source code comprises:
when the component has an expansion tag of type, determining that the component is made with the loose coupling to register a topic in the topic list in the topic list display window.

16. The method of claim 10, further comprising:
when the individual component displayed on the component list display window is drawn and put it on the application diagram display window, interpreting the component standard; and
when an interface port in the component is made with the loose coupling, marking near the port a note indicating that the port is connected to the topic.

17. The method of claim 10, wherein said creating an application package comprises:
when the port is made with the tight coupling, creating the connection information which specifies the component in a source and a target of the application package so that a direct connection is made between the components.

18. The method of claim 10, wherein said creating an application package comprises:
when the port is made with the loose coupling, creating the connection information included in the application package which specifies a source as the component and a target as a topic as for a publication and vice versa as for a subscription so that the component and the topic are connected.
